(19) United States
(12) Patent Application Publication
(10) Pub. No.: US 2004/0155959 A1
(43) Pub. Date: Aug. 12, 2004

(54) Aerial video camera system

(76) Inventor: David W. Cullens, Longwood, FL (US)

Correspondence Address: EDWARD M. LIVINGSTON, PA, 963 TRAIL TERRACE DRIVE, NAPLES, FL, 34103, US

(21) Appl. No.: 10/772,098

(22) Filed: Feb. 3, 2004

Related U.S. Application Data
(63) Continuation-in-part of application No. 09/710,483, filed on Nov. 9, 2000.

(51) Int. Cl. H04N 7/18

(52) U.S. Cl. 348/144; 348/143

(57) ABSTRACT

An aerial video camera (1, 11) has control communication from a universal-control computer (2) and a vibration damper (6, 7, 8). The camera is rotatable circumferentially and tiltable inside of a hemispherical radome (10) that is suspended from a camera pod (9) which is attached to a wing-strut bolt (14) of an aircraft (3) with preferably an attachment bracket (13). Pan and tilt site of the camera are communicated electronically to a monitor (12) of the universal-control computer having a joystick control (20).

### CROSS-REFERENCE TO RELATED APPLICATION

This is a Continuation-In-Part of patent application Ser. No. 09/710,483 filed on Nov. 9, 2000.

### BACKGROUND OF THE INVENTION

This invention relates to stabilized aircraft video cameras which are attachable to aircraft and operated with a universal-control computer having photo vision on a video monitor proximate an aircraft-pilot seat from a computer-control camera having control vision that is directional in unison with direction of the aircraft video camera.

Aircraft cameras for surveillance, mapping, communicating and reporting surface features and conditions are well known. None, however, are known to have the gyroscopic, non-shaking stability, joystick camera direction with computer-monitor view, low weight, attachment convenience and low cost taught by this invention.

Examples of most-closely related but different prior art are described in the following patent documents.

| U.S. Pat. No.: | Inventor: | Issue Date: |
|---|---|---|
| 6,604,038 | Lesesky, et al. | Aug. 5, 2003 |
| 6,454,601 | Monroe | Apr. 8, 2003 |
| 6,324,489 | Millgard | Nov. 27, 2001 |
| 5,897,223 | Tritchew et al. | Apr. 27, 1999 |
| 5,426,476 | Fussell et al. | Jun. 20, 1995 |

This invention differs fundamentally from Lesesky et al.(U.S. Pat. No. 6,604,038), Fussell et al.(U.S. Pat. No. 5,426,476) and Monroe U.S. Pat. No. 6,454,601). Neither separately or combinatorially have or teach either the computer-control system or the vibration damping taught by Applicant.

Tritchew et al., (U.S. Pat. No.5,897,223), teaches a vibration-damping system, but it is an elaborate, expensive and heavy spring-enclosure device that differs basically from a spring-leg vibration-damping system taught by this invention.

### SUMMARY OF THE INVENTION

Objects of patentable novelty and utility taught by this invention are to provide an aerial video camera system which:

has unobstructed camera pan and tilt view on a monitor that is conveniently visible by an aircraft pilot and/or passenger;

is operable with a universal-control computer in an aircraft;

has spring-leg attachment with giro prevention of camera shake;

is quickly and easily attached to a wing strut tie-down bolt hole;

has additional video signal available for recording and/or broadcasting; and

does not require aircraft-system electricity for aircraft certification.

This invention accomplishes these and other objectives with an aerial video camera having computerized control with view from a camera lens to an aircraft pilot and/or passenger through a computer monitor. Computerized control includes pushbutton operation and universal joystick directing of the camera with a universal-control computer that is articulated and positioned for convenient access by the pilot. The camera is spring-mounted with giro prevention of camera shake inside of a camera pod. A camera lens has swivel pan-and-tilt viewing through a transparent hemispherical radome on a bottom of the camera pod.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF DRAWINGS

This invention is described by appended claims in relation to description of a preferred embodiment with reference to the following drawings which are explained briefly as follows:

FIG. 1 is a partially cutaway side view of a camera on a pan-tilt head with giro shake prevention and spring mount in a radome and camera pod attached to a strut tie-down of a top-wing aircraft;

FIG. 2 is a partially cutaway front view of the top-wing aircraft having the camera pod attached to the strut bolt of the top-wing aircraft with the universal-control computer and monitor in relationship to a pilot position;

FIG. 3 is a bottom view of the radome showing spring vibration-damper springs and outlining giros and the camera in dashed lines;

FIG. 4 is a top view of the universal-control computer showing controls; and

FIG. 5 is a rear view of the universal-control computer showing a power switch and computer sockets.

### DESCRIPTION OF PREFERRED EMBODIMENT

Listed numerically below with reference to the drawings are terms used to describe features of this invention. These terms and numbers assigned to them designate the same features throughout this description and patent claims that follow.

| | |
|---|---|
| 1. | Camera |
| 2. | Universal-control computer |
| 3. | Aircraft |
| 4. | Pan-tilt head |
| 5. | Base plate |
| 6. | Linear giro |
| 7. | Lateral giro |
| 8. | Resilient mount |
| 9. | Camera pod |
| 10. | Radome |
| 11. | Digital camera |
| 12. | Monitor |
| 13. | Attachment bracket |
| 14. | Wing-strut bolt |
| 15. | Lift wing |
| 16. | Wing strut |
| 17. | Counter-resilient fasteners |
| 18. | Top ends |
| 19. | Bottom ends |
| 20. | Joystick |
| 21. | Toggle switch |
| 22. | Power LED |
| 23. | Speed knob |
| 24. | Pushbuttons |
| 25. | Forward portion |
| 26. | Aft portion |
| 27. | Control lines. |
| 28. | Stabilizer fin |
| 29. | Bottom resilient member |
| 30. | Top resilient member |
| 31. | Spring legs |
| 32. | Stabilizer fin bracket |

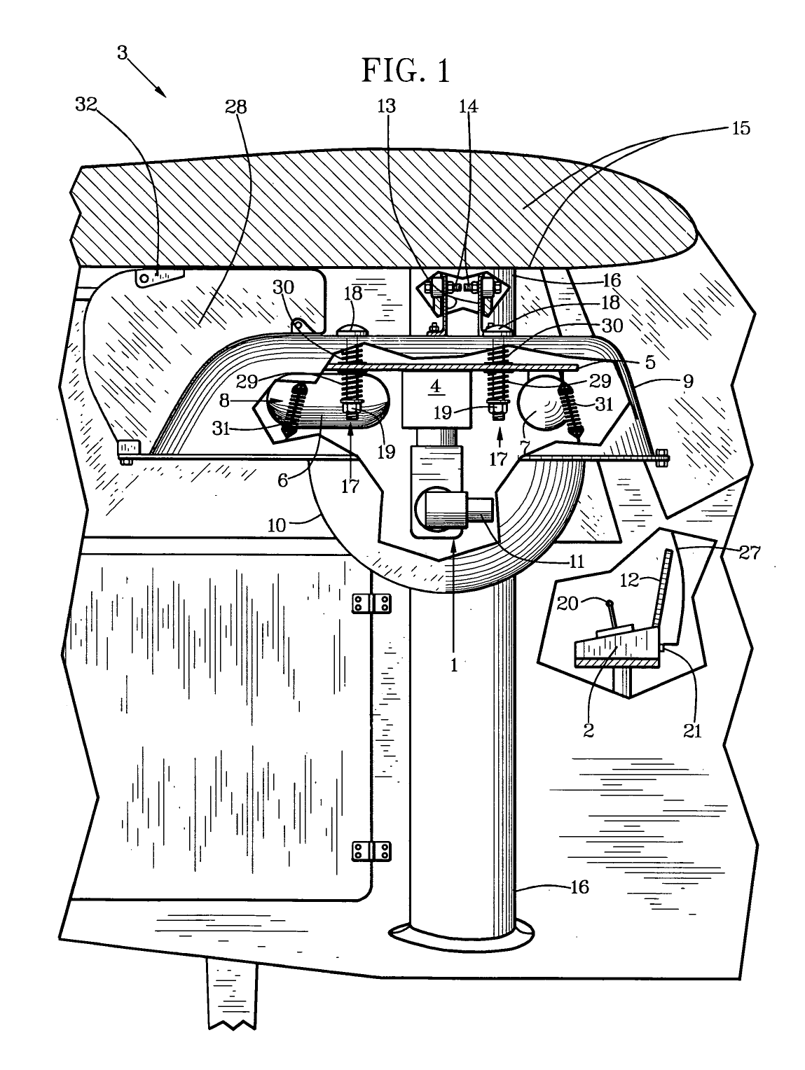

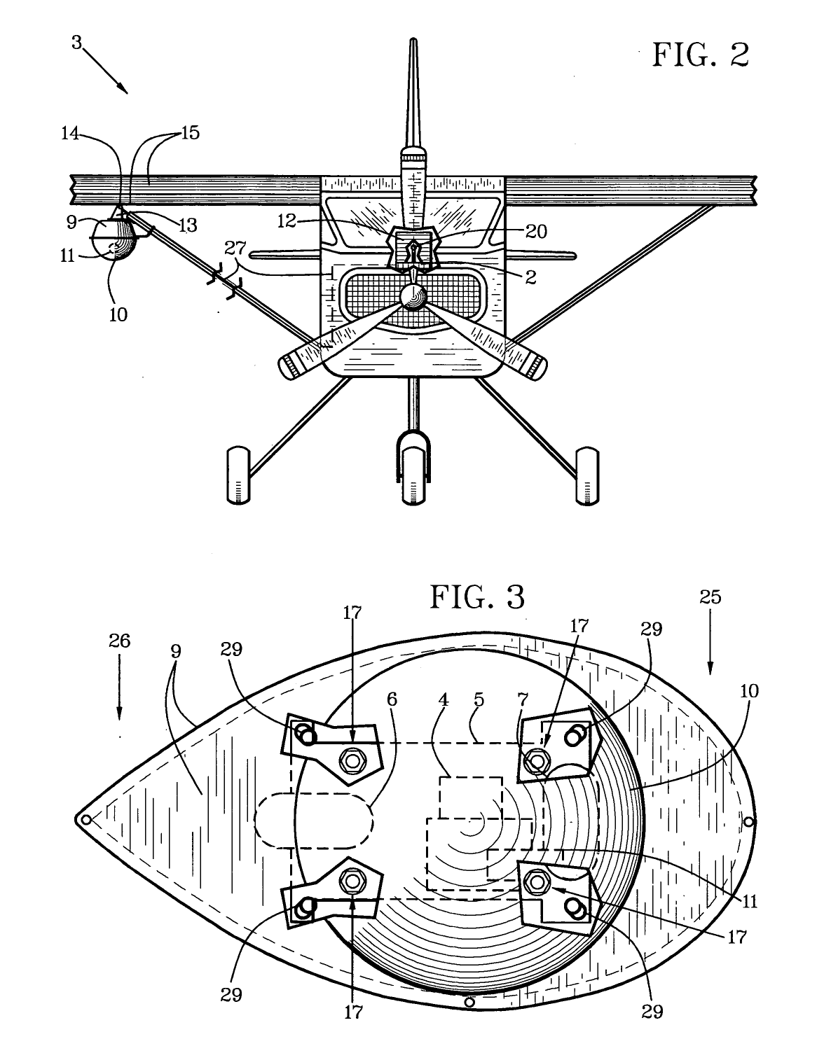

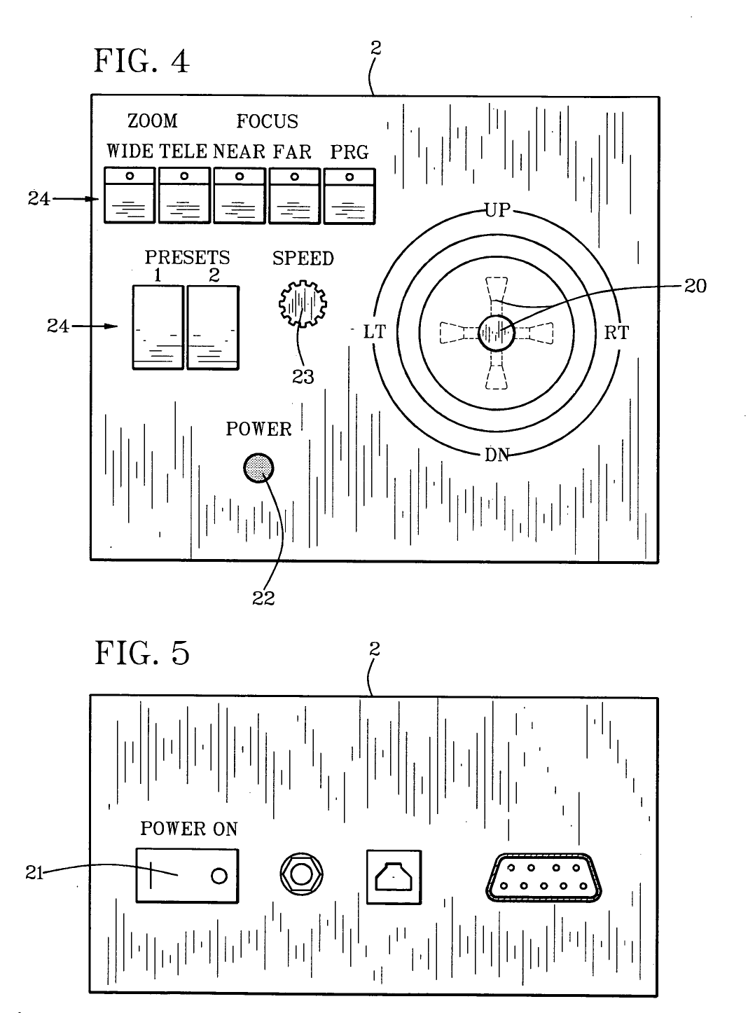

Referring to FIGS. 1-5, a camera (1) has electronic control by a universal-control computer (2) that is positioned predeterminedly in an aircraft (3). The camera (1) is attached to a pan-tilt head (4) that is suspended rigidly from a base plate (5) in a camera pod (9). A linear giro (6) and a lateral giro (7) are affixed to the base plate (5) for universal damping of vibration from the aircraft (3). The vibration from the aircraft (3) is absorbed by a resilient mount (8) intermediate the base plate (5) and the camera pod (9) that is attached to the aircraft (3).

A transparent radome (10) is extended downwardly from a bottom of the camera pod (9) for housing swivel panning and tilting view for the camera (1) and for camera control with the universal-control computer (2).

There is electronic-control communication having control lines (27) intermediate the universal-control computer (2), the camera (1) and the pan-tilt head (4).

The camera (1) can include a digital camera (11) from which a field of view of optical signal is transmitted to and shown on a monitor (12) for the universal-control computer (2). The signal is also available for recording and/or broadcasting to a remote monitor which could even be located at a ground station.

The camera pod (9) has an attachment bracket (13) that is articulated for attaching the camera (1) to the aircraft (3) with a wing-strut bolt (14) proximate a junction of a bottom member of a lift wing (15) and a wing strut (16) of the aircraft (3).

The attachment bracket (13) can include articulation for supporting the camera (1) on a predetermined aircraft-camera support.

Swivel panning of the camera (1) on the pan-tilt head (4) is 270° horizontally rotational.

The camera pod (9) includes a predeterminedly aerodynamic surface having an arcuate-airfoil forward portion (25), a pointedly narrow aft portion (26) and the attachment bracket (13) extended upwardly from a top surface. Also included on the camera pod (9) is a stabilizer fin (28) with bracket (13) for attachment to the under surface of a wing. The attachment bracket (13) is sized and shaped to attach to the wing tie-down holes. A stabilizer fin bracket (32) provides increased support, longitudinal stability and improved aerodynamics for the device.

The resilient mount (8) can include counter-resilient fasteners (17) having counter-resilient support of the base plate (5) on the camera pod (9). The counter-resilient fasteners (17) have top ends (18) supported by a top of the camera pod (9) and bottom ends (19) positioned in support of a bottom resilient member (29) under a bottom side of the base plate (5). A top resilient member (30) is positioned intermediate the camera pod (9) and the base plate (5).

Spring legs (31) with predetermined slanting orientation can be included for vibration damping intermediate the camera pod (9) and the base plate (5).

The universal-control computer (2) includes joystick control of horizontally panning and vertically tilting of the camera (1) on the pan-tilt head (4) with a joystick (20). The universal-control computer (2) can include toggle-switching of power on and off with a toggle switch (21) as indicated with a power LED (22).

The universal-control computer (2) can include control of camera speed with a speed knob (23).

The universal-control computer (2) can include control of a plurality of camera features of the camera (1) and the digital camera (11)with predetermined pushbuttons (24). The plurality of camera features can include focus and zoom.

Without the linear giro (6) and the lateral giro (7), the aerial video camera system can include the camera (1) having electronic control by the universal-control computer (2) and selected additional features described above.

A new and useful aerial video camera system having been described, all such foreseeable modifications, adaptations, substitutions of equivalents, mathematical possibilities of combinations of parts, pluralities of parts, applications and forms thereof as described by the following claims and not precluded by prior art are included in this invention.

What is claimed is:

1. An aerial video camera system comprising:
a camera having electronic control by a universal-control computer that is positioned predeterminedly in an aircraft;
the camera being attached to a pan-tilt head that is suspended rigidly from a base plate in a camera pod;
a linear giro and a lateral giro affixed to the base plate for universal damping of vibration from the aircraft;
the vibration from the aircraft being absorbed by a resilient mount intermediate the base plate and the camera pod that is attached to the aircraft;
a transparent radome that is articulated and extended downwardly from a bottom of the camera pod for housing swivel panning and tilting view for the camera; and
electronic-control communication having control lines intermediate the universal-control computer, the camera and the pan-tilt head.

2. The aerial video camera system of claim 1 wherein:
the camera includes a digital camera from which a field of view of optical signal is transmitted to and shown on a monitor of the universal-control computer and available for recording and broadcasting.

3. The aerial video camera system of claim 1 wherein:
the camera pod includes an attachment bracket that is articulated for attaching the camera to the aircraft with a wing-strut bolt proximate a junction of a bottom member of a lift wing and a wing strut of the aircraft.

4. The aerial video camera system of claim 3 wherein:
the attachment bracket includes articulation for supporting the camera on a predetermined aircraft-camera support.

5. The aerial video camera system of claim 1 wherein:
swivel panning of the camera on the pan-tilt head is horizontally rotational.

6. The aerial video camera system of claim 1 wherein:
the camera pod includes a predeterminedly aerodynamic surface having an arcuate-airfoil forward portion, a pointedly narrow aft portion and the attachment bracket extended upwardly from a top surface; and
the attachment bracket is sized and shaped to receive a portion of the wing-strut bolt.

7. The aerial video camera system of claim 1 wherein:
the resilient mount includes counter-resilient fasteners having counter-resilient support of the base plate on the camera pod;
the counter-resilient fasteners have top ends supported by a top of the camera pod and bottom ends positioned in support of a bottom resilient member under a bottom side of the base plate; and
a top resilient member is positioned intermediate the camera pod and the base plate.

8. The aerial video camera system of claim 1 wherein:
the universal-control computer includes joystick control of horizontally panning and vertically tilting of the camera on the pan-tilt head with a joystick.

9. The aerial video camera system of claim 1 wherein:
the universal-control computer includes toggle-switching of power on and off with a toggle switch as indicated with a power LED.

10. The aerial video camera system of claim 1 wherein:
the universal-control computer includes control of camera speed with a speed knob.

11. The aerial video camera system of claim 1 wherein:
the universal-control computer includes control of a plurality of camera features of the camera and the digital camera with predetermined pushbuttons.

12. The aerial video camera system of claim 11 wherein:
the plurality of camera features include focus and zoom.

13. An aerial video camera system comprising:
a camera having electronic control by a universal-control computer that is positioned predeterminedly in an aircraft;
a transparent radome that is articulated and extended downwardly from the camera pod for housing swivel panning and tilting view for the camera; and
electronic-control communication having control lines intermediate the camera and the universal-control computer.

14. The aerial video camera system of claim 13 wherein:
the camera is attached to the pan-tilt head that is suspended rigidly from the base plate;
the linear giro and the lateral giro are affixed to the base plate for universal damping of vibration from the aircraft; and
the vibration from the aircraft is absorbed by the resilient mount intermediate the base plate and the camera pod that is attached to the aircraft.

15. The aerial video camera system of claim 14 wherein:
the resilient mount includes counter-resilient fasteners having counter-resilient support of the base plate on the camera pod;
the counter-resilient fasteners have top ends supported by a top of the camera pod and bottom ends positioned in support of a bottom resilient member under a bottom side of the base plate; and
a top resilient member is positioned intermediate the camera pod and the base plate.

16. The aerial video camera system of claim 13 wherein:
the camera includes a digital camera from which a field of view of optical signal is transmitted to and shown on a monitor of the universal-control computer and available for recording and broadcasting.

17. The aerial video camera system of claim 13 wherein:
the camera pod includes an attachment bracket that is articulated for attaching the camera to the aircraft with a wing-strut bolt proximate a junction of a bottom member of a lift wing and a wing strut of the aircraft.

18. The aerial video camera system of claim 13 wherein:
swivel panning of the camera on the pan-tilt head is full-circle horizontally rotational.

19. The aerial video camera system of claim 13 wherein:
the universal-control computer includes joystick control of horizontally panning and vertically tilting of the camera on the pan-tilt head with a joystick.

20. The aerial video camera system of claim 19 wherein:
the universal-control computer includes control of a plurality of camera features of the camera.

21. The aerial video camera system of claim 20 wherein:
the plurality of camera features include on-off switching, camera speed camera focus and camera zoom.
